(19) United States
(12) Patent Application Publication
(10) Pub. No.: US 2006/0253829 A1
(43) Pub. Date: Nov. 9, 2006

(54) Selective solution determination for a multiparametric system

(76) Inventor: Peter Gschwendner, Lauda-Königshofen (DE)

Correspondence Address: BACHMAN & LAPOINTE, P.C., 900 CHAPEL STREET, SUITE 1201, NEW HAVEN, CT, 06510, US

(21) Appl. No.: 10/484,969

(22) PCT Filed: Feb. 26, 2002
(86) PCT No.: PCT/EP02/02025

§ 371 Date: Jun. 12, 2006

(30) Foreign Application Priority Data
Aug. 6, 2001 (DE) 101 37 790.8

(51) Int. Cl. G06F 9/44

(52) U.S. Cl. 717/101

(57) ABSTRACT

Selective solutions for a multiparametric system. An input of values and/or value ranges is effected for a multitude of parameters by which the solution finding should occur. In addition, an input of a definition of one or more relationships between the parameters and/or one or more exclusion criteria, which should serve to exclude certain possible solutions, is/are effected. Solutions of this type from a possibility search space, which are excluded by the input relationships and/or by exclusion criteria, are discarded, whereby the possibility search space has solutions that are possible on the basis of the parameter input. The solutions that are not discarded from the possibility search space are finally presented, for example, to a user.

### BACKGROUND OF THE INVENTION

The present invention relates to a method for ascertaining one or more solutions for a multiparameter system, particularly for software, and also to an apparatus and a system for ascertaining one or more solutions.

In many of the currently available computation programs for ascertaining solutions for a multiparameter system, a user is required to input a series of data which a computation program uses to ascertain corresponding results. Should a plurality of variants be examined, the user needs to create them independently. From the multiplicity of all the solutions, the user then needs to apply various decision criteria, and sometimes needs to perform external intermediate calculations, in order to carry out a selection process until a solution which is acceptable to him has been found.

In one example of such a computation program, the aim is to find a suitable cogging for a gear unit. Possible parameters for the gear unit may in this case be the height and width of the teeth, the angle of skew for the teeth, materials used, surface treatment methods etc., to name but a few of the possible parameters. For many applications, 10, 20 or else many more different parameters may be involved here. The computation program then uses the input values to compute values for prescribed output parameters, such as in this example: security against tooth breakage, surface fatigue, noise, forces etc.

Every combination of values for the input parameters delivers one or more results comprising values for corresponding output parameters.

Specifically in the technical field, this procedure requires a high level of technical knowledge, extensive knowledge regarding, by way of example, a piece of software used for the computation program, and a not inconsiderable time involvement, since it is necessary to examine ever more variants for their suitability for the desired solution, to compare them with one another and possibly to subject them to an assessment scheme (ranking) regarding current criteria. The information content of the solution(s) ultimately selected is then processed further, typically in a wide variety of ways, and is edited, for example in the form of documentation or an offer.

Depending on the performance of the computation program used, solutions are found manually according to the principle of “trial and error”, which means that solution finding also involves the generation of a great number of less suitable variants which ultimately burden the decision-making process unnecessarily. When the chosen input parameters take critical forms, the number of unsuitable variants often exceeds the number of suitable solutions, generally even by a multiple. The search for implementable solutions is then equivalent to looking for a needle in a haystack.

In cases in which an implementable solution does not exist, the (actually pointless) search before finally giving up takes the longest time, with uncertainty remaining about whether an existing solution has actually been overlooked.

In many computation programs, unergonomic user guidance and the frequent appearance of various warnings and error messages usually make the search for a solution additionally confusing and ineffective and quickly drive the user to frustration and rejection.

If the search for a solution has to be performed under time pressure, the search is quite usually aborted when a first solution has been found. Searching for better solutions or even for the best solution cannot be done for reasons of time. Any optimization potential which may still exist is not used and, in extreme cases, is sometimes even used by the competitor as a starting point for attacks of any kind.

In computation programs which do not work out solution variants, the user himself has to design a system of organization and has to archive the solutions found by a plurality of individual computations as appropriate. If this is neglected or is not done using the necessary logic, the knowledge about the origin of the variants and the contexts of their content may be lost and may not subsequently become transparent again. In addition, joint project work between a plurality of employees or transfer to other employees is made extremely difficult.

It is therefore an object of the present invention to improve the finding of a suitable solution in a multiparameter system.

### SUMMARY OF THE INVENTION

The foregoing object is achieved by providing a method for ascertaining one or more solutions for a multiparameter system, having the following steps:

(a) values and/or value ranges are input for a multiplicity of parameters which are intended to be used to find the solution,

(b) a definition is input for one or more relationships between the parameters and/or for one or more exclusion criteria which are intended to be used to exclude particular possible solutions,

(c) those solutions which are excluded by the relationships which have been input and/or by the exclusion criteria are rejected from a possibility search area, said possibility search area containing the solutions which are possible on the basis of the input of parameter values, and

(d) the solutions which have not been rejected from the possibility search area are transferred. The invention further includes an apparatus for carrying out the method.

In an ascertainment program based on the present invention for ascertaining one or more solutions for a multiparameter system, an input is first made to define values and/or value ranges for a multiplicity of parameters which are intended to be used to find the solution. Besides the parameter values, it is also possible to define relationships between the parameters, for example by inputting rankings, dependencies, conditions etc. among one another. It is also possible to stipulate exclusion criteria (“k.o. criteria”) which are intended to be used to exclude particular possible solutions.

It will readily be seen that the relationships, exclusion criteria etc. between the parameters can also be defined before or after the input of parameter values, that is say that these steps do not have to take place simultaneously. In addition, these steps can also be performed by different people, bodies, institutions, groups etc. In other words, these steps can be completely independent of one another, both from a temporal and a personal point of view, with “personal” not necessarily being limited to people, but also including computerized or automated processes. It is thus possible, by way of example, for parameter values to be input by a user of a piece of software specific to this purpose, while the relationships, exclusion criteria etc. between the parameters can be wholly or partially predefined by an operator of this software, for example in advance. In this case, this definition does not need to be the same for all users, but rather can be specified for each of them (e.g. using prescribed or definable profiles or on the basis of experience, history etc.). In addition, this definition can also be specified for particular user groups, for example for beginners/entrants/advanced users/professionals or particular vocational groups (e.g. fitters/architects/DIY handymen/building owners) etc.

It is also possible to prescribe a selection of parameters and/or relationships, exclusion criteria etc. between parameters for their input/definition on the basis of the respective user. It is thus possible to take a respective user profile, for example, as a basis for prescribing for a user A just a selection of three parameters P1, P2 and P3 for input, while not just five parameters P1, P2, P4, P5 and P6 but also particular relationships, exclusion criteria etc. between these parameters are prescribed to a user B for input. In line with the above, these or other parameters and/or relationships, exclusion criteria etc. which are then used for ascertaining a solution are then reserved, prescribed or defined in different ways for different users. The respective needs, demands or problems of the respective users can thus be considered on an individual basis.

The input of parameter values is used to define a possibility search area which contains the combinations which are possible on the basis of the input of parameter values. This possibility search area is then searched by a solution search engine in line with the relationship(s), defined in the input, among the parameters, and unwanted solutions defined by these relationships and/or by exclusion criteria are rejected from the possibility search area. If there is a defined relationship of rank among the parameters, the possibility search area, from which the unwanted solutions have been removed, is sorted into a selection list as appropriate. The selection list is then transferred to the user, and the user can revise the selection list further. It is thus possible for one or any number of solution variants to be selected directly for further processing, or the scope of the selection list can be reduced using further arbitrary criteria, so that, by way of example, optimum solutions become visible directly. Optionally, it is also possible to transfer a list of the solutions or some of the solutions which have been rejected from the possibility search area, for example in order to make the search for a solution more transparent for the user or to search for errors or to improve the search for a solution further. It is also possible to align the form or format for the respective transfer with or for the user, so that, by way of example, the data are configured specifically for a piece of software belonging to the user (e.g. for further processing of these data).

In one preferred embodiment, the selection list has, for at least one solution variant, a link to an associated document which represents this solution variant in the context of a desired application. In the case of the example mentioned at the outset for the ascertainment of suitable gear cogging, for example, it is thus possible to present the solution variant found in definite terms as a drawing and/or design profile specifically for the gear unit. In this case, the link to the associated document can be in a form such that customer-specific features are taken into account for the document, such as a customer-specific document layout etc.

In one preferred embodiment of the inventive ascertainment program, the parameter values can be defined indistinctly, i.e. the parameter values do not need to be quantized exactly, but rather it is possible to define relative values and interrelationships, for example. This means that data input can be aligned dynamically and with the application's current problem area. Typical indistinct wordings in this case can be: “It is imperative for . . . ”, “It would not be bad if additionally . . . ”, “However, the aim is not . . . ” or “It does not matter if . . . ”. These indistinct definitions can be evaluated using ordinary means, such as fuzzy logic.

The inventive reduction of the possibility search area to the selection list means that combinations which (for whatever reason) cannot be implemented or which are unwanted for other reasons are blanked out and there is thus no need to assess these less suitable or technically unimplementable variants and to reject them again as appropriate. This obviates the need for interaction with the user, and in the case of a software implementation, for example, the user interface does not require any intelligence of its own.

Operation of the ascertainment program is dissociated from technical knowledge by the invention and is thus possible by anyone at first go. The erroneous selection of a solution which does not work can accordingly be prevented from the outset. In one preferred exemplary embodiment, the invention's ascertainment program is executed by software, with the input being made locally or using a browser. This component requires no intelligence of its own and can thus be in the form of an HTML page or in the form of a simple Java applet or C program, for example. The simple design means that it is possible to implement arbitrary interface variants as required, for example to address a multilingual facility.

The solution search engine is preferably executed on a server which can be located at a physically remote point from the input facility and is preferably optimized and specified for this application in the form of a solution search engine.

The local input facility and the remote solution search engine can communicate via any data network, such as an LAN, WAN or the Internet.

When the selection list has been obtained, an ultimate selection can be made offline, i.e. separately from the solution search engine, which allows data protection to be ensured. Any attacker sees only the selection list, which is typically relatively useless on account of its size and the associated wealth of data, however.

Instead of sequential ascertainment of the possibility search area and subsequent selection of the desired solutions to form the selection list, these steps can also be combined with one another, so that the selection list is generated directly. As soon as a solution variant is identified as invalid, it is rejected directly. Only valid solution variants are retained and directly included in the selection list. The separate step involving creation of the possibility search area is dispensed with accordingly. As already mentioned above, the solutions rejected from the possibility search area can likewise be transferred, for example in a separate list.

### BRIEF DESCRIPTION OF THE DRAWINGS

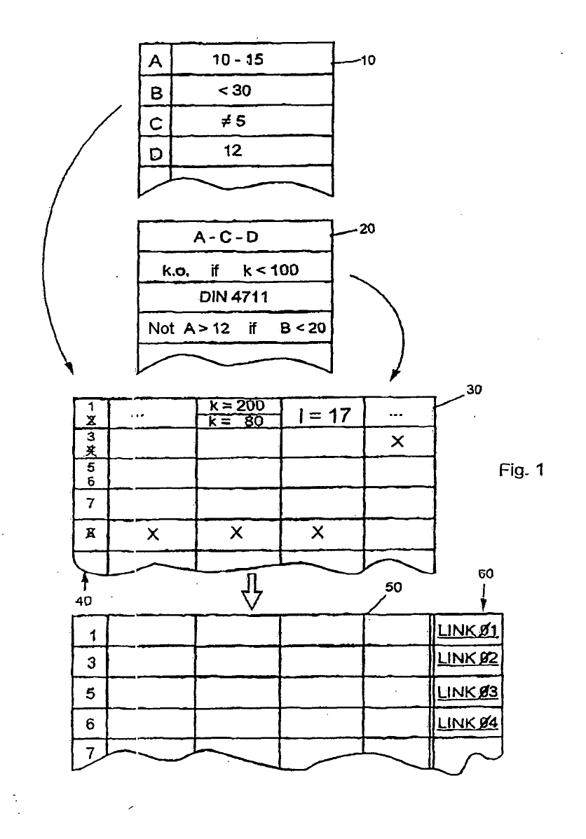

Other advantages, features and details of the invention can be found in the description below of a preferred exemplary embodiment, with regard to FIG. 1 which shows a schematically illustrated function sequence.

### DETAILED DESCRIPTION

FIG. 1 uses an arbitrary example to illustrate the function sequence in an ascertainment program based on the present invention and shows the principle of the invention. To find one or more solutions in a multiparameter system, parameter values are first defined in an input step 10. To this end, a multiplicity of parameters A, B, C, . . . are assigned values or sets of values. In the example shown in FIG. 1, a parameter A is assigned a value range from 10 to 15, a parameter B is assigned a value range less than 30, a parameter C is assigned a value range not equal to 5, and a parameter D is assigned a value equal to 12.

In the example in this case, this parameter value assignment is intended to be made by a user of the ascertainment program. However, the parameters for this assignment are prescribed by an operator of the ascertainment program, with the parameter stipulation being able to be aligned with the respective user on the basis of a user profile which the user can preferably define himself. The user profile can then be aligned (e.g. interactively or adaptively) further with the user, for example by identifying and omitting in future those parameters which the respective user has not defined or has defined incorrectly.

In a further input step 20, it is now possible to stipulate further conditions or relationships among the parameters and also exclusion criteria (k.o. criteria). In the example shown in FIG. 1, the relationship of rank stipulated for parameters A, C and D is that A has priority over C, and C has priority over D. In addition, the exclusion criterion defined is that the value for a solution parameter k must not be smaller than 100. Furthermore, the solution needs to satisfy a standard DIN 4711. Finally, the condition defined between the parameters A and B is that A must not be greater than 12 if B is smaller than 20.

In the example in this case, the definition for a portion of these conditions, relationships or exclusion criteria is intended to be made by the user of the ascertainment program, whereas the remaining portion thereof has already been predefined by an operator of the ascertainment program (for example on the basis of a prescribed user profile).

For the parameter values defined in step 10, a possibility search area 30 is now ascertained which represents a multiplicity of solutions 40 which are respectively defined by values of solution parameters, for example. In FIG. 1, a solution No 1 has a value of 200 for a solution parameter k and a value of 17 for a solution parameter 1, for example.

It will be seen that, particularly for value range details for parameters (in step 10), it is necessary to define, in a prior configuration step, in what gradations these ranges are to be considered. Without any definition, it is also possible to start from a preset for a gradation, if said preset is not being changed by the user. The chosen gradation density is taken as a basis for enlarging or reducing the possibility search area. In the example in FIG. 1, the configuration is intended to be, by way of example, that integer gradation is intended to be effected for the value range 10-15 of the parameter A, so that the values 10, 11, 12, 13, 14 and 15 are considered for the parameter A. Accordingly, gradation in steps of five is intended to be effected for the parameter B, for example, so that the values 25, 20, 15, . . . are considered.

When the possibility search area 30 has been opened out, the number of solutions 40 is narrowed down by applying the criteria 20. In the example in FIG. 1, solution No 2 is rejected, for example, since the value of the solution parameter k is equal to 80 and therefore the k.o. criterion (k.o. if k<100) has been met. Solution No 4 is rejected, for example, because in this case the criterion (not A>12, if B<20) has been met and this solution is therefore not accepted. Solution No 8 is intended to be rejected in this case because this solution does not conform to the demanded DIN 4711.

From the possibility search area 30 the remaining solution variants are then selected and are put into order in a selection list 50. For the arrangement of the solution variants in the selection list 60, it is possible in this case to take into account prescribed rank criteria (particularly for the solution parameters of the solution variants) and to incorporate and present the solution variants on the basis of their ranks. In the example shown in FIG. 1, the solutions 40 which have not been sorted out of the possibility search area 30 are selected. The selection list thus contains the solution variants No 1, 3, 5, 6 and 7. The solutions which have been sorted out can likewise be transferred to the user on request, e.g. for error searching or process optimization.

In one preferred embodiment, every selected solution variant is now also assigned at least one document 60 which presents this solution variant in the context of the desired application. In the example shown in FIG. 1, the solution variant is assigned a document (not shown) specifying the found solution No 1 by means of a “hyperlink” LINK01, and a drawing shows a gear unit in line with this solution. Correspondingly, solution variant No 3 is assigned a document by means of a hyperlink LINK02, etc.

In one preferred embodiment of the invention, the input steps 10 and 20 are performed locally on a computer or in a browser. Since these steps 10 and 20 do not require any intelligence of their own, there is no difficulty in their being in the form of an HTML page, a simple Java applet or a C program, for example. By contrast, the possibility search area 30 is preferably ascertained on a server designed and optimized specifically for this purpose, which is located remotely from the computer used for the input steps 10 and 20. Correspondingly, the solution search engine required for setting up the selection list 50 also runs on this server or on a correspondingly different server and can be, by way of example, an AnsiC program optimized for speed. In the case of an AnsiC implementation, the search engine can be compiled for any platform, including UNICOS.

Instead of sequential ascertainment of the possibility search area 30 and selection of the desired solutions to form the selection list 50, these steps can also be combined with one another, so that the selection list 50 is generated directly. As soon as a solution variant is identified as invalid, it is rejected directly only valid solution variants are retained and directly included in the selection list 50. The separate step involving creation of the possibility search area 30 is dispensed with accordingly.

The selection list 50 is preferably presented and edited using a spreadsheet program. The documentation 60 can comprise ready-made masks (e.g. HTML masks) which, when called up, have only the current parameters put into them. The layout can thus be shaped by any user himself when required.

1. A method for ascertaining one or more solutions for a multiparameter system, having the following steps:
(a) values and/or value ranges are input (10) for a multiplicity of parameters which are intended to be used to find the solution,
(b) a definition is input (20) for one or more relationships between the parameters and/or for one or more exclusion criteria which are intended to be used to exclude particular possible solutions,
(c) those solutions which are excluded by the relationships which have been input and/or by the exclusion criteria are rejected from a possibility search area (30), said possibility search area containing the solutions which are possible on the basis of the input of parameter values, and
(d) the solutions (50) which have not been rejected from the possibility search area are transferred.

2. The method as claimed in claim 1, in which step (c) comprises the following steps:
(c1) the possibility search area (30) containing the solutions which are possible on the basis of the input of parameter values is ascertained, and
(c2) the possibility search area is searched for the solutions which are to be rejected.

3. The method as claimed in claim 1, in which step (d) involves the unrejected solutions being transferred to a selection list.

4. The method as claimed in claim 3, in which the selection list is in sorted form, according to at least one solution parameter for the solutions.

5. The method as claimed in claim 1, in which step (b) involves the input of at least one relationship from ranking, dependency or conditions.

6. The method as claimed in claim 1, having a step prior to step (d) in which at least one document (60) is assigned to at least one solution, with the document representing this solution variant in the context of a desired application.

7. The method as claimed in claim 1, in which at least one of the input steps (a) or (b) involves an indistinct definition being produced, preferably by relative values and/or interrelationships.

8. The method as claimed in claim 1, in which the input steps (a) and (b) are independent of one another from a temporal and/or personal point of view.

9. The method as claimed in claim 1, in which the input steps (a) and (b) are performed in reverse order in time and/or by different people, bodies, institutions, groups etc.

10. The method as claimed in claim 1, in which at least one of the input steps (a) and (b) is performed wholly or partially by a user, while the input steps which are not performed wholly or partially by the user are performed by another person.

11. The method as claimed in claim 10, in which the other person performs the input steps which are not performed wholly or partially by the user on an individual basis or on the basis of the user's specific group.

12. The method as claimed in claim 1, in which at least one of the input steps (a) and (b) involves a stipulation specified for the user being made for the input, preferably on the basis of a respective user profile.

13. A software program or product, preferably stored on a data storage medium, which is suitable for performing the method as claimed in claim 1 when said software program or product is running on a data processing system, such as a computer.

14. An apparatus for ascertaining one or more solutions for a multiparameter system, having:
a unit for inputting (10) values and/or value ranges for a multiplicity of parameters which are intended to be used to find the solution, and for inputting (20) a definition for one or more relationships between the parameters and/or for one or more exclusion criteria which are intended to be used to exclude particular possible solutions,
a unit for rejecting those solutions which are excluded by the relationships which have been input and/or by the exclusion criteria from a possibility search area (30), said possibility search area containing the solutions which are possible on the basis of the input of parameter values, and
a unit for transferring the solutions (50) which have not been rejected from the possibility search area.

15. A system for ascertaining one or more solutions for a multiparameter system, having:
a first local data processing unit suitable for inputting values and/or value ranges for a multiplicity of parameters which are intended to be used to find the solution, and for inputting a definition for one or more relationships between the parameters and/or for one or more exclusion criteria which are intended to be used to exclude particular possible solutions,
a second data processing unit suitable for rejecting those solutions which are excluded by the relationships which have been input and/or by the exclusion criteria from a possibility search area, and for transferring the solutions which have not been rejected from the possibility search area, said possibility search area containing the solutions which are possible on the basis of the input of parameter values.

16. The system as claimed in claim 15, in which the first local data processing unit has no intelligence of its own and has an HTML page, a Java applet and/or a C program.

17. The system as claimed in claim 15, in which the second data processing unit has a solution search engine.

18. The system as claimed in claim 15, in which communication between the first and second data processing units takes place via a data network, preferably an LAN, WAN or the Internet.
